(19) United States
(12) Patent Application Publication
(10) Pub. No.: US 2025/0250429 A1
(43) Pub. Date: Aug. 7, 2025

(54) Polyolefin Composition Comprising Polypropylene Polymers and Recycled Plastic Materials

(71) Applicant: Borealis AG, Vienna (AT)

(72) Inventors: Susanne Margarete Kahlen, Linz (AT); Hermann Braun, Linz (AT); Meta Cigon, Wien (AT); Philip Knapen, Beringen (BE); Andreas Roessler-Czermak, Linz (AT)

(21) Appl. No.: 18/880,859

(22) PCT Filed: Jul. 3, 2023
(86) PCT No.: PCT/EP2023/068172

§ 371 Date: Jan. 3, 2025

(30) Foreign Application Priority Data
Jul. 4, 2022 (EP) 22182842.9

(51) Int. Cl. C08L 23/14; B29C 48/00; B29C 48/39; B29C 48/40; B29K 23/00; B29K 105/00; C08F 2/01; C08F 210/06; C08K 5/13; C08K 5/14

(52) U.S. Cl. CPC C08L 23/142; B29C 48/022; B29C 48/39; B29C 48/40; C08F 2/01; C08F 210/06; C08K 5/13; C08K 5/14; B29K 2023/04; B29K 2023/12; B29K 2023/16; B29K 2105/0085; B29K 2995/0012; B29K 2995/0089; C08L 2205/025; C08L 2205/03; C08L 2207/02; C08L 2207/20

(57) ABSTRACT

Provided is polyolefin composition including a) 35-65 wt % (based on the overall weight of the polyolefin composition) of at least one heterophasic polypropylene copolymer with a total ethylene C2 content of 6-15 wt %, an ethylene content of the soluble fraction C2 (SF) content of 25-40 wt % and with a melt flow rate MFR₂ (230° C., 2.16 kg, measured according to ISO 1133) in the range of 60 to 90 g/10 min; and b) 35-65 wt % (based on the overall weight of the polyolefin composition) of a blend of recycled plastic material comprising polypropylene and polyethylene in a ratio of 3:7 to 49.5:1, which is recovered from a waste plastic material derived from post-consumer and/or post-industrial waste, c) optionally further additives, wherein the sum of all ingredients always adds up to 100 wt %.

### CROSS-REFERENCE TO RELATED APPLICATIONS

This application is the United States national phase of International Patent Application No. PCT/EP2023/068172 filed Jul. 3, 2023, and claims priority to European Patent Application No. 22182842.9 filed Jul. 4, 2022, the disclosures of each of which are hereby incorporated by reference in their entireties.

### BACKGROUND

### Technical Field

The present disclosure relates to a polyolefin composition comprising at least one heterophasic polypropylene copolymer and recycled plastic material, to an article comprising the polyolefin composition and a process for preparing such polyolefin composition.

Technical Considerations Polyolefins, in particular polyethylene and polypropylene are increasingly consumed in large amounts in a wide range of applications, including packaging for food and other goods, fibers, automotive components, and a great variety of manufactured articles. Taking into account the huge amount of waste collected compared to the amount of waste recycled back into the stream, there is still a great potential for intelligent reuse of plastic waste streams and for mechanical recycling of plastic wastes.

One major trend in the field of polyolefins is the use of recycled materials, which are derived from a wide variety of sources. Durable goods streams such as those derived from yellow bags, yellow bins, community collections, waste electrical equipment (WEE) and/or end-of-life vehicles (ELV) contain a wide variety of plastics. These materials can be processed to recover acrylonitrile-butadiene-styrene (ABS), high impact polystyrene (HIPS), polypropylene (PP) and/or polyethylene (PE) plastics. Separation can be carried out using density separation in water and then further separation based on fluorescence, near infrared absorption or raman fluorescence. However, it is commonly quite difficult to obtain either pure recycled polypropylene or pure recycled polyethylene.

Generally, recycled quantities of polypropylene on the market are mixtures of both polypropylene (PP) and polyethylene (PE), this is especially true for post-consumer waste streams. Moreover, commercial recyclates from post-consumer waste sources are conventionally cross-contaminated with non-polyolefin materials such as polyethylene terephthalate, polyamide, polystyrene and/or non-polymeric substances like wood, paper, glass and/or aluminum. These cross-contaminations drastically limit final applications of recycling streams such that no profitable final uses remain. Polyolefinic recycling materials, especially from post-consumer waste streams, are a mixture of PE and PP. The better the quality of the recyclate is, the less available it is and the more expensive it is.

The quality issue in recyclates compared to the virgin ones can be to some extent overcome by mixing the recyclates with virgin polymers.

Compositions comprising virgin polymers (i.e., polymers used for the first time) and recycled mixed plastics have been studied.

EP 0 575 465 B1 discloses a polymer blend composition comprising (a) 30-70 wt % of low melting polymer comprising an ethylene/α-olefin copolymer having a density of from 0.88-0.915 g/cm³, an MFR of 1.5-7.5 dg/min, a molecular weight distribution no greater than 3.5, a composition distribution breadth index greater than 70 percent and an essentially single melting point in the range of 60° C. to 115° C. measured as a DSC peak Tm; and (b) 70-30 wt % of a propylene based polymer having from 88 to 100 mole percent propylene and from 12 to 0 mole percent of an alpha-olefin other than propylene.

U.S. Pat. No. 5,266,392 A claims a polyethylene/polypropylene blend, comprising >50 wt % of crystalline polypropylene; at least about 10 wt % of linear low density polyethylene having a density of about 0.915 to about 0.94 dispersed in a matrix of said polypropylene; and an amount of an ethylene/alpha-olefin plastomer compatibilizer having an alpha-olefin content of from ˜5-˜25 mol %, a melt index of above about 50 dg/min, a weight average molecular weight between about 5000 and about 50,000, a density of from about 0.88 about 0.90 g/cm³ and an X-ray crystallinity of at least 10%. This covers the use of plastomers as compatibilizers in a very general way, including of course recycling. Only rather low and rather high densities are excluded for the plastomer, but pure HDPE is also excluded.

WO 2015/169690 A1 refers to polypropylene-polyethylene blends comprising (A) 75-90 wt % of a blend of (A-1) 30-70 wt % of polypropylene and (A-2) 70-30 wt % of polyethylene and (B) 10-25 wt % of a compatibilizer being a heterophasic polyolefin composition comprising (B-1) 55-90 wt % of a polypropylene with an MFR₂ between 1.0 and 300 g/10 min (according to ISO 1133 at 230° C. at a load of 2.16 kg) and (B-2) 45-10 wt % of a copolymer of ethylene and propylene or C4 to C10 alpha olefin with a glass transition temperature Tg (measured with DMTA) of below −25° C. and an intrinsic viscosity (measured in decalin at 135° C.) of at least 3.0 dl/g, whereby the blend has (i) a Charpy Notched Impact Strength (according to ISO 179-1 eA, measured at 23° C.) of at least 2% higher than for the same blend without the compatibilizer (B) and at the same time (ii) a Flexural Modulus (according to ISO 178) of at least 3% higher than for the same blend without the compatibilizer (B) and additionally (iii) a heat deflection resistance (determined with DMTA) expressed by the temperature at which the storage modulus G′ of 40 MPa is reached (T(G′=40 MPa)) which is at least 4° C. higher than for the same blend without the compatibilizer (B).

EP 3 165 473 A1 relates to polyolefin compositions comprising a blend (A) of recycled polypropylene and recycled polyethylene, a polypropylene having an MFR of not lower than 50 g/10 min, and a compatibilizer being a heterophasic polyolefin composition, wherein the whole composition has a MFR of higher than 25 g/10 min.

WO 2020/070176 A1 relates to polyolefin compositions which comprise recycled polyolefins and which are suitable for higher value products. The composition comprises a propylene homopolymer with an MFR of at least 400 g/10 min.

WO2021/032458 A1 and WO2021/144404 A1 disclose polypropylene-polyethylene blends comprising a component A) being a recyclate blend and a component B) being a virgin heterophasic polypropylene copolymer. However, the polypropylene-polyethylene blends have a rather low tensile modulus and/or melt flow rate making them not suitable for certain applications.

However, the known polymer compositions comprising recycled materials are not suited for a high-end market, rather the presently available recyclate compositions target low end applications such as crates, flower pots and benches etc. The presently available recyclate compositions cannot compete with virgin materials due to their mechanical properties.

In order to serve a high-end market e.g. for high flow applications and to compete with virgin materials (in particular in the area of non-food and non-health care products), certain adjustments need to be made. Currently available recyclates are facing main problems in composition (such as fluctuation in PP and PE content), in consistency (in terms of flow properties), in their property profile (poor stiffness-impact balance), and in cross-contamination (such as non-polyolefinic components, inorganic materials such as aluminum or paper) but also in colour and odour.

### SUMMARY

Thus, it was an object of the present disclosure to provide a polyolefin composition comprising polyolefin material recovered from waste plastic material without the disadvantages of the polymer compositions according to the prior art. A compound solution of a virgin material in combination with a recyclate is of an urgent need to balance out the above mentioned issues and to serve advanced material products for the market.

### DETAILED DESCRIPTION

This object has been solved by providing a polyolefin composition comprising:
a) 35-65 wt % (based on the overall weight of the polyolefin composition) of at least one heterophasic polypropylene copolymer with a total ethylene C2 content of 6-15 wt %, an ethylene content of the soluble fraction C2 (SF) of 25-40 wt % and with a melt flow rate MFR₂ (230° C., 2.16 kg, measured according to ISO 1133) in the range of 60 to 90 g/10 min; and
b) 35-65 wt % (based on the overall weight of the polyolefin composition) of a blend of recycled plastic material comprising polypropylene and polyethylene in a ratio of 3:7 to 49.5:1, which is recovered from a waste plastic material derived from post-consumer and/or post-industrial waste,
c) optionally further additives, wherein the sum of all ingredients always adds up to 100 wt %,
   wherein the polyolefin composition has
   an impact strength (ISO179-1, Charpy 1 eA+23° C.) of 5-8 kJ/m²,
   a melt flow rate MFR₂ (230° C., 2.16 kg, measured according to ISO 1133) of 30 to 80 g/10 min, and
   a tensile modulus (Iso 527-2) in the range of 1450 to 1600 MPa.

As discussed in detail further below the polyolefin composition according to the present disclosure is obtained by extruding the at least one heterophasic polypropylene copolymer and the blend of recycled plastic material in the presence of at least one peroxide. Surprisingly, by doing so a polyolefin composition was obtained that combines a high impact strength with good MFR and high tensile modulus. Even though the present polyolefin composition was obtained in the presence of at least one peroxide in the extrusion process, the present polyolefin composition is (almost) free of peroxide; i.e., if at all only trace amounts of peroxide are detectable.

The present polyolefin composition combines both a recycling material to fulfill recycling quotes and to help to reduce waste but also a virgin material to compensate for the variations/composition issues in the recyclate. By providing polyolefin compositions with combining high impact, melt flow and tensile modulus customer needs can be met.

The present polyolefin composition combines virgin high flow heterophasic polypropylene material as impact booster for the recycled PP/PE material. This allows for the use of the polyolefin composition with a high amount of recycled material for current applications in the field of caps and closures and packaging like lids, for example in thin wall packaging applications.

It is to be understood that the present polyolefin composition does not comprise talc (except the amounts present in the recyclate), glass fibers, rubber or any other solid material. It is further to be understood that the present polyolefin composition preferably does not contain or comprise any virgin polypropylene homopolymer except as matrix of a heterophasic polypropylene copolymer and as a dosing agent.

For the purposes of the present disclosure, the term “recycled” indicates that the material is recovered from post-consumer waste and/or post-industrial waste. Namely, post-consumer waste refers to objects having completed at least a first use cycle (or life cycle), i.e., having already served their first purpose and been through the hands of a consumer; while post-industrial waste refers to the manufacturing scrap which does normally not reach a consumer. The “recycled polymers” may also comprise up to 17 wt %, or up to 3 wt %, or up to 1 wt % or up to 0.1 wt % based on the overall weight of the recycled polymer of other components originating from the first use. Type and amount of these components influence the physical properties of the recycled polymer. The physical properties given below refer to the main component of the recycled polymer.

As described also further below, typical other components originating from the first use are thermoplastic polymers, for example polystyrene and/or PA 6, talc, chalk, ink, wood, paper, limonene and/or fatty acids. The content of polystyrene (PS) and polyamide 6 (PA 6) in recycled polymers can be determined by Fourier Transform Infrared Spectroscopy (FTIR) and the content of talc, chalk, wood and paper may be measured by Thermogravimetric Analysis (TGA).

The term “virgin” denotes the newly produced materials and/or objects prior to first use and not being recycled. In case that the origin of the polymer is not explicitly mentioned the polymer is a “virgin” polymer.

The total amount of virgin heterophasic polypropylene polymers used in the polyolefin composition may add up to a range of 40-60 wt %, or 45-55 wt %, or 48-52 wt % (based on the overall weight of the polymer composition).

The amount of the blend of recycled plastic material comprising polypropylene and polyethylene in a ratio of 3:7 and 49.5:1, or 3:7 and 12:1, which is recovered from a waste plastic material derived from post-consumer and/or post-industrial waste, used in the present polyolefin composition may be in a range of 40-60 wt %, or 45-55 wt %, or 48-52 wt % (based on the overall weight of the polymer composition).

It is to be understood that the amounts of heterophasic propylene copolymer (PPHECO) and blend of recycled material are always complementary to each other. For example, the composition may comprise in some non-limiting embodiments 60 wt % heterophasic propylene copolymer (PPHECO) and 40 wt % polypropylene recyclate, or 55 wt % heterophasic propylene copolymer (PPHECO) and 45 wt % polypropylene recyclate, or 50 wt % heterophasic propylene copolymer (PPHECO) and 50 wt % polypropylene recyclate or anything in between.

In some non-limiting embodiments, the polyolefin composition may comprise
70 wt % heterophasic propylene copolymer (PPHECO) and 30 wt % polypropylene recyclate;
65 wt % heterophasic propylene copolymer (PPHECO) and 35 wt % polypropylene recyclate;
60 wt % heterophasic propylene copolymer (PPHECO) and 40 wt % polypropylene recyclate;
55 wt % heterophasic propylene copolymer (PPHECO) and 45 wt % polypropylene recyclate; or
50 wt % heterophasic propylene copolymer (PPHECO) and 50 wt % polypropylene recyclate.

The impact strength (ISO179, charpy 1 eA+23° C.) of the polymer composition is in a range of 5 to 8 kJ/m², or 5.2 to 7.5 kJ/m², or 5.5 to 7 kJ/m², or 5.8 to 6.5 kJ/m².

In some non-limiting embodiments, the polyolefin composition is further characterized by a melt flow rate MFR₂ (230° C., 2.16 kg, measured according to ISO 1133-1) of 30 to 80 g/10 min, or 30 to 75 g/10 min, or 35 to 70 g/10 min, or between 30 to 36 g/10 min.

In some non-limiting embodiments, the polyolefin composition is characterized by a tensile modulus (ISO 527-2) of 1450 to 1600 MPa, or 1450 to 1550 MPa, or 1450 to 1500 MPa, or 1460 to 1500 MPa.

In some non-limiting embodiments, the polyolefin composition may have an impact strength of 5.5 to 6.5 kJ/m², a melt flow rate MFR₂ of 30 to 36 g/10 min and a tensile modulus of 1455 to 1500 MPa.

### Heterophasic Polypropylene Virgin Polymer (PPHeco)

Heterophasic polypropylene copolymers comprise as polymer components a polypropylene matrix (M) and an elastomeric copolymer (E). The polypropylene matrix (M) is preferably a random propylene copolymer or a propylene homopolymer, the latter being preferred. The elastomeric copolymer (E) comprises units derived from propylene and ethylene and/or C4 to C20 alpha-olefins, or from ethylene and/or C4 to C10 alpha-olefins or from ethylene, C4, C6 and/or C8 alpha-olefins, e.g., ethylene and, optionally, units derived from a conjugated diene.

The at least one heterophasic polypropylene copolymer may have a melt flow rate MFR₂ (230° C., 2.16 kg, measured according to ISO 1133) in the range of 60 to 90 g/10 min, or 650 to 90 g/10 min, or 70 to 90 g/10 min, or 70 to 85 g/10 min

The at least one heterophasic polypropylene copolymer used as virgin polymer in the present polyolefin composition is
at least one heterophasic polypropylene copolymer (PPHeco-1) having a melt flow rate MFR₂ (230° C., 2.16 kg, measured according to ISO 1133) in the range of 60 to 90 g/10 min, or 70 to 90 g/10 min, or 72 to 88 g/10 min;
at least one heterophasic polypropylene copolymer (PPHeco-2) having a melt flow rate MFR₂ (230° C., 2.16 kg, measured according to ISO 1133) in the range of 65 to 80 g/10 min, or 65 to 75 g/10 min, or mixtures thereof.

It is to be understood that the present polyolefin composition may comprise not only one, but two heterophasic virgin polypropylene copolymers with different melt flow rates. This allows for an adjustment of the melt flow rate of the final polyolefin composition.

### Heterophasic Polypropylene Copolymer (PPHeco-1):

The at least one heterophasic polypropylene copolymer (PPHeco-1) has a melt flow rate MFR₂ (230° C., 2.16 kg, measured according to ISO 1133) in the range of 60 to 90 g/10 min, or 70 to 90 g/10 min, or 72 to 88 g/10 min.

The heterophasic polypropylene polycopolymer (PPHeco-1) has a content of soluble fraction (SF), determined according to CRYSTEX analysis, within the range of 10.0 to 25.0 wt %, or 15.0 to 20.0 wt %, or 16.0 to 18.0 wt %. based on the total weight of the heterophasic polypropylene copolymer.

The soluble fraction (SF) of the heterophasic polypropylene copolymer (PPHeco-1) has an ethylene content (C2(SF)), as determined by quantitative FT-IR spectroscopy calibrated by ¹³C-NMR spectroscopy, in the range of 25.0 to 40.0 wt %, or 25.0 to 35.0 wt %, or 30.0 to 32.0 wt %.

The soluble fraction (SF) of the heterophasic polypropylene copolymer (PPHeco-1) has an intrinsic viscosity (iV(SF)) of not more than 3.5 dl/g, or not more than 2.5 dl/g, or 1.0 to 3.5 dl/g, or 1.2 to 1.5 dl/g, such as 1.23 or 1.46 dl/g.

The heterophasic polypropylene copolymer (PPHeco-1) preferably has a total ethylene (C2) content, as determined by quantitative FT-IR spectroscopy calibrated by ¹³C-NMR spectroscopy, of 6.0 to 15.0 wt %, or 6 to 10.0 wt %, or 6.0 to 8.0 wt %.

The heterophasic polypropylene copolymer (PPHeco-1) may have a Charpy Notched Impact Strength (NIS) measured according to ISO 179-1 eA at 23° C. of at least 4 kJ/m², or at least 5 kJ/m², or 4 to 7 kJ/m², or 4 to 6 kJ/m², or 4 kJ/m² or 5 kJ/m². The heterophasic polypropylene copolymer (PPHeco-1) may have a tensile modulus measured according to ISO 178 of at least 1000 MPa, or at least 1400 MPa, or 1000 to 2000 MPa, or 1200 to 1800 MPa, or 1300 MPa.

The heterophasic polypropylene copolymer (PPHeco-1) is known in the art and commercially available for example from Borealis AG.

### Heterophasic Polypropylene Copolymer (PPHeco-2):

The at least one heterophasic polypropylene copolymer (PPHeco-2) has a melt flow rate MFR₂ (230° C., 2.16 kg, measured according to ISO 1133) of 60 to 90 g/10 min, or 65 to 80 g/10 min, or 65 to 75 g/10 min.

The heterophasic polypropylene copolymer (PPHeco-2) has a content of soluble fraction (SF), determined according to CRYSTEX analysis, of 10.0 to 20.0 wt %, or 15.0 to 18.0 wt %, based on the total weight of the heterophasic polypropylene copolymer.

The soluble fraction (SF) of the heterophasic polypropylene copolymer (PPHeco-2) has an ethylene content (C2(SF)), as determined by quantitative FT-IR spectroscopy calibrated by ¹³C-NMR spectroscopy, of 25.0 to 40.0 wt %, or 25.0 to 35.0 wt %, or 25.0 to 30.0 wt %.

The soluble fraction (SF) of the heterophasic polypropylene copolymer (PPHeco-2) has an intrinsic viscosity (iV(SF)) of not more than 4.5 dl/g, or not more than 3.5 dl/g, or 2.0 to 4.5 dl/g, or 2.5 to 3.5 dl/g, or 2.5 to 3.0 dl/g, or 2.6 to 2.7 dl/g.

The heterophasic polypropylene copolymer (PPHeco-2) preferably has a total ethylene (C2) content, as determined by quantitative FT-IR spectroscopy calibrated by ¹³C-NMR spectroscopy, of 6.0 to 15.0 wt %, or 6 to 10.0 wt %, or 6.0 to 8.0 wt %.

The heterophasic polypropylene copolymer (PPHeco-2) may have a Charpy Notched Impact Strength (NIS) measured according to ISO 179-1 eA at 23° C. of at least 4 kJ/m², or at least 5 kJ/m², or 4 to 7 kJ/m², or 5 to 6 kJ/m², or 5 kJ/m². The heterophasic polypropylene copolymer (PPHeco-2) may have a tensile modulus measured according to ISO 178 of at least 1000 MPa, or at least 1400 MPa, or 1000 to 2000 MPa, or 1300 to 1800 MPa, or 1500M Pa.

The heterophasic propylene copolymer (PPHeco-2) is known in the art and commercially available for example from Borealis AG.

### Blend of Recycled Material

The blend is obtained from a recycled waste stream. The blend can be either recycled post-consumer waste and/or post-industrial waste, such as for example from the automobile industry, or alternatively, a combination of both. It is preferred that blend consists of recycled post-consumer waste and/or post-industrial waste.

In some non-limiting embodiments or aspects, the blend may be a polypropylene (PP) rich material of recycled plastic material that comprises significantly more polypropylene than polyethylene. Recycled waste streams, which are high in polypropylene can be obtained for example from the automobile industry, for example as some automobile parts such as bumpers are sources of fairly pure polypropylene material in a recycling stream or by enhanced sorting. PP rich recyclates may also be obtained from yellow bag feedstock when sorted accordingly. The PP rich material may be obtainable by selective processing, degassing and filtration and/or by separation according to type and colors such as NIR or Raman sorting and/or VIS sorting. It may be obtained from domestic waste streams (i.e., it is a product of domestic recycling) for example the “yellow bag” recycling system organized under the “Green dot” organization, which operates in some parts of Germany.

In some non-limiting embodiments, the polypropylene rich recycled material is obtained from recycled waste by means of plastic recycling processes known in the art. Such PP rich recyclates are commercially available, e.g., from Corepla (Italian Consortium for the collection, recovery, recycling of packaging plastic wastes), Resource Plastics Corp. (Brampton, ON), Kruschitz GmbH, Plastics and Recycling (AT), Vogt Plastik GmbH (DE), mtm Plastics GmbH (DE) etc. Non-limiting examples of polypropylene rich recycled materials comprise: Dipolen@PP, Purpolen@PP (Mtm Plastics GmbH), MOPRYLENE PC B-420 White, MOPRYLENE PC B 440 (Morssinkhof Plastics, NL), SYSTALEN PP-C24000; Systalen PP-C44000; Systalen PP-C14901, Systalen PP-C17900, Systalen PP-C2400, Systalen 13704 GR 015, Systalen 13404 GR 014, Systalen PP-C14900 GR000 (Der Grune Punkt, DE), and/or Vision (Veolia) PPC BC 2006 HS or PP MONO.

It is considered that the present disclosure could be applicable to a broad range of recycled polypropylene materials or materials or compositions having a high content of recycled polypropylene. The polypropylene-rich recycled material may be in the form of granules.

As mentioned previously, the polyolefin composition comprises as blend a polymer blend, comprising polypropylene and polyethylene; wherein the weight ratio of polypropylene to polyethylene is from 3:7 to 49.5:1; and wherein the polymer blend is a recycled material.

In some non-limiting embodiments, the weight ratio of polypropylene to polyethylene is 7:1 to 40:1, or 10:1 to 30:1. The weight ratio of polypropylene to polyethylene is preferably 19:1 to 7:3.

According to some non-limiting embodiments, the blend of recycled plastic material comprises a relative amount of units derived from propylene of greater than 50 wt %, or greater than 53 wt %, or greater than 60 wt %, or greater than 70 wt %, or greater than 75 wt %, or greater than 80 wt %, or greater than 90 wt %, or greater than 95 wt %, with respect to the total weight of the composition of blend.

In some non-limiting embodiments, the content of polypropylene a1) in the blend is 75-99 wt % or 83-95 wt % based on the overall weight of blend of recyclate material. The content of polypropylene in blend may be determined by FTIR spectroscopy as described in the experimental section. More preferably the polypropylene component of the recyclate blend comprises more than 95 wt %, or 96-99.9 wt % isotactic polypropylene or consists of isotactic polypropylene.

Furthermore, the blend may have a relative amount of units derived from ethylene of less than 47 wt %, or less than 40 wt %, or less than 30 wt %, or less than 20 wt %, or less than 10 wt %. The recyclate blend preferably comprises units derived from ethylene in an amount of 5.0 to 17.5 wt.-%, or 6.0 to 15.0 wt.-%, or 7.5 to 13.0 wt.-%. Usually, the relative amount of units derived from ethylene is more than 5 wt % with respect to the total weight blend. It is to be understood that the ethylene present is preferably ethylene derived from polyethylene and ethylene containing copolymers.

In some non-limiting embodiments, the content of polyethylene a2) in the blend is 1-25 wt %, or 5-20 wt %, or 7-17 wt %, based on the overall weight of blend A). The content of polyethylene a2) in blend may be determined by Crystex as described in the experimental section. More preferably component a2) consists of polyethylene and ethylene containing copolymers.

The blend of recycled plastic material is suitably characterized by CRYSTEX QC analysis. In the CRYSTEX QC analysis, a crystalline fraction (CF) and a soluble fraction (SF) are obtained which can be quantified and analyzed in regard of the monomer and comonomer content as well as the intrinsic viscosity (iV).

The blend of recycled plastic material shows the following properties in the CRYSTEX QC analysis:
a crystalline fraction (CF) content determined according to CRYSTEX QC of 82.5 to 96.0 wt %, or 84.0 to 95.5 wt %, or 85.0 to 95.0 wt %, and
a soluble fraction (SF) content determined according to CRYSTEX QC analysis or 4.0 to 17.5 wt %, or 4.5 to 16.0 wt %, or 5.0 to 15.0 wt %.

Said crystalline fraction (CF) has one or more, preferably all of the following properties:
an ethylene content (C2(CF)), as determined by FT-IR spectroscopy calibrated by quantitative ¹³C-NMR spectroscopy, of 1.0 to 12.5 wt %, or 1.5 to 11.0 wt %, or 2.0 to 10.0 wt %; and/or
an intrinsic viscosity (iV(CF)), as measured in decalin according to DIN ISO 1628/1 at 135° C., of 1.0 to below 2.6 dl/g, or 1.2 to 2.5 dl/g, or 1.3 to 2.4 dl/g.

Said soluble fraction (SF) has one or more, preferably all of the following properties:
an ethylene content (C2(SF)), as determined by FT-IR spectroscopy calibrated by quantitative ¹³C-NMR spectroscopy, preferably of 20.0 to 55.0 wt %, or 22.0 to 50.0 wt %, or 24.0 to 48.0 wt %; and/or
an intrinsic viscosity (iV(SF)), as measured in decalin according DIN ISO 1628/1 at 135° C., of 0.9 to 2.5 dl/g, or 1.0 to 2.3 dl/g, or 1.1 to 2.2 dl/g.

The polyethylene fraction of the recycled material can comprise recycled high-density polyethylene (rHDPE), recycled medium-density polyethylene (rMDPE), recycled low-density polyethylene (rLDPE), linear low density polyethylene (LLDPE) and/or the mixtures thereof. In some non-limiting embodiments, the recycled material is high density PE with an average density of greater than 0.8 g/cm³, or greater than 0.9 g/cm³, or greater than 0.91 g/cm³.

The polyethylene fraction of the recycled material may also comprise a plastomer. A plastomer is a polymer material that combines rubber-like properties with the processing ability of plastic. Important plastomers are ethylene-alpha olefin copolymers.

The ethylene based plastomer is preferably a copolymer of ethylene and a C₄-C₈ alpha-olefin. Non-limiting examples of C₄-C₈ alpha-olefins comprise 1-butene, 1-hexene and/or 1-octene, preferably 1-butene or 1-octene and more preferably 1-octene. Preferably, copolymers of ethylene and 1-octene are used. Such ethylene based plastomers are commercially available, i.e., from Borealis AG (AT) under the tradename Queo, from DOW Chemical Corp (USA) under the tradename Engage or Affinity, or from Mitsui under the tradename Tafmer. Alternatively, the ethylene based plastomer can be prepared by known processes, in a one stage or two stage polymerization process, comprising solution polymerization, slurry polymerization, gas phase polymerization or combinations therefrom, in the presence of suitable catalysts, like vanadium oxide catalysts or single-site catalysts, e.g. metallocene or constrained geometry catalysts, known to the art skilled persons. It is possible that the ethylene based plastomer is already contained in the post-consumer and/or post-industrial waste being used for the production of recyclate blend. Alternatively, it is possible that the ethylene based plastomer is added to the post-consumer and/or post-industrial waste during the waste plastic recycling process where the recyclate blend is produced.

In some non-limiting embodiments, the recyclate blend comprises less than 5 wt %, or less than 3 wt %, or 0.01 to 2 wt % based on the overall weight of the recyclate blend of thermoplastic polymers different from polypropylene and polyethylene, or less than 4.0 wt % PA 6 and less than 5 wt % polystyrene, or preferably the blend comprises 0.5-3 wt % polystyrene.

According to some non-limiting embodiments, the recyclate blend comprises less than 5 wt %, or less than 4 wt %, or 0.01 to 4 wt % based on the overall weight of the recyclate blend of talc.

In some non-limiting embodiments, the recyclate blend comprises less than 4 wt %, or less than 3 wt %, or 0.01 to 2 wt % based on the overall weight of the recyclate blend of chalk.

According to some non-limiting embodiments, the recyclate blend comprises less than 1 wt.-%, or less than 0.5 wt %, or 0.01 to 1 wt % based on the overall weight of the recyclate blend of paper.

In some non-limiting embodiments, the recyclate blend comprises less than 1 wt %, or less than 0.5 wt %, or 0.01 to 1 wt % based on the overall weight of the recyclate blend of wood.

In some non-limiting embodiments, the recyclate blend comprises less than 1 wt %, or less than 0.5 wt %, or 0.01 to 1 wt % based on the overall weight of the recyclate blend of metal.

According to some non-limiting embodiments, the recyclate blend has a content of limonene as determined using solid phase microextraction (HS-SPME-GC-MS) of 0.1 ppm to 100 ppm, or 1 ppm to 50 ppm, or 2 ppm to 35 ppm. Limonene is conventionally found in recycled polyolefin materials and originates from packaging applications in the field of cosmetics, detergents, shampoos and similar products. Therefore, the recyclate blend contains limonene, when the recyclate blend comprises material that originates from such types of domestic waste streams.

The fatty acid content is yet another indication of the recycling origin of the recyclate blend. However, in some cases, the fatty acid content may be below the detection limit due to specific treatments in the recycling process. According to some non-limiting embodiments, the recyclate blend preferably has a content of fatty acids as determined using solid phase microextraction (HS-SPME-GC-MS) of 1 ppm to 200 ppm, or 1 ppm to 150 ppm, or 2 ppm to 100 ppm, or 3 ppm to 80 ppm.

In some non-limiting embodiments or aspects, the recyclate blend (i) comprises less than 5 wt %, or less than 1.5 wt % polystyrene; and/or (ii) comprises less than 3.5 wt %, or less than 1 wt % talc; and/or (iii) comprises less than 1.0 wt %, or less than 0.5 wt % polyamide.

Due to the recycling origin blend may also comprise organic fillers, and/or inorganic fillers, and/or additives in amounts of up to 10 wt %, or 3 wt % with respect to the weight of the blend.

Thus, in some non-limiting embodiments of the present polyolefin composition the blend of recycled plastic material comprises
A-1) a content of polypropylene of 50-99 wt %,
A-2) a content of polyethylene of 1-40 wt %,
A-3) 0-5.0 wt % of polystyrene and/or copolymers such as ABS,
A-4) 0-3.0 wt % stabilizers,
A-5) 0-4.0 wt % polyamide-6,
A-6) 0-3.0 wt % talc,
A-7) 0-3.0 wt % chalk,
A-8) 0-1.0 wt % paper,
A-9) 0-1.0 wt % wood,
A-10) 0 to 0.5 wt % metal,
A-11) 0.1 ppm-100 ppm of limonene as determined by using solid phase microextraction (HS-SPME-GC-MS), and
A-12) 0-200 ppm total fatty acid content as determined by using solid phase microextraction (HS-SPME-GC-MS)
wherein all amounts are given with respect to the total weight of the recyclate blend.

As stated above the recyclate blend may comprise one or more further components, selected from:
A-4) up to 3.0 wt % stabilizers, or up to 2.0 wt % stabilizers,
A-5) up to 4.0 wt % polyamide-6, or up to 2.0 wt % polyamide-6,
A-6) up to 3.0 wt % talc, or up to 1.0 wt % talc,
A-7) up to 3.0 wt % chalk, or up to 1.0 wt % chalk,
A-8) up to 1.0 wt % paper, or up to 0.5 wt % paper,
A-9) up to 1.0 wt % wood, or up to 0.5 wt % wood, and
A-10) up to 0.5 wt % metal, or up to 0.1 wt % metal, based on the overall weight of the recyclate blend.

In some non-limiting embodiments, the blend of recycled plastic material comprising polypropylene and polyethylene has a melt flow rate MFR₂ (230° C., 2.16 kg, measured according to ISO 1133) of at least 5 g/10 min, or at least 10 g/10 min, or at least 15 g/10 min, or 5-50 g/10 min, or 10-45 g/10 min, or 15-40 g/10 min.

According to some non-limiting embodiments the blend of recycled plastic material may have a melt flow rate MFR₂ (ISO 1133, 230° C., 2.16 kg) of 15 to 50 g/10 min or 18 to 36 g/10 min.

In some non-limiting embodiments, the Charpy Notched Impact Strength measured according to ISO 179-1 eA at 23° C. of the recyclate blend is more than 3.0 kJ/m², or 4.0 to 8.0 kJ/m² or 5.0 to 6.0 kJ/m².

In some non-limiting embodiments, the Tensile Modulus measured according to ISO527-2 of the recyclate blend is 800 to 1500 MPa or 1100 to 1400 MPa.

In some non-limiting embodiments, the recyclate blend preferably has one or more, or preferably all of the following properties:
a melt flow rate MFR₂ (230° C., 2.16 kg, ISO1133) of 6.0 to 40 g/10 min, or 8.0 to 40 g/10 min, or 9.0 to 36 g/10 min; and/or
a polydisperstiy index PI of 2.0 to 5.0 Pa-1, or 2.2 to 4.5 Pa⁻¹, or 2.5 to 4.0 Pa⁻¹; and/or
a complex viscosity at 0.05 rad/s eta_{0.05} of from 1000 kPa·s to 5000 kPa·s, or 1200 kPa·s to 4500 kPa·s, or 1400 kPa·s to 4000 kPa·s; and/or
a complex viscosity at 300 rad/s eta_{0.05} of 100 kPa·s to 500 kPa·s, or 150 kPa·s to 400 kPa·s, or 175 kPa·s to 300 kPa·s, and/or
a density of 905 to 930 kg/m³, or 910 to 925 kg/m³, or 913 to 922 kg/m³; and/or
a limonene content as determined by using solid phase microextraction (HS-SPME-GC-MS): 0.1 ppm to 50 ppm; and/or
a tensile modulus of from 1000 MPa to 1500 MPa, or 1100 MPa to 1400 MPa; and/or
a Charpy Notched Impact Strength at 23° C. (CNIS at 23° C.) of 3.0 to 7.5 kJ/m², or 4.0 to 7.0 kJ/m².

A recyclate bend (Blend B1) that is preferably used is available from mtm Plastics GmbH. Blend B1 is a post-consumer recyclate polypropylene based material having a density (determined according to DIN EN ISO 1183) of 916 kg/m³, a melt flow rate (determined according to DIN EN ISO 1133, 230° C./2.16 kg) of 36 g/10 min, a moisture content (determined via a moisture infrared analyzer, 105° C.) of less than 0.1%, a tensile modulus (determined according to DIN EN ISO 527, 1 mm/min) of more than 1100 MPa, a yield stress (determined according to DIN EN ISO 527, 50 mm/min) of more than 24 MPa, and a tensile strain (determined according to DIN EN ISO 527, 50 mm/min) of more than 18%.

Other recyclate blends that may be used are now described.

Blend B2:
total C2 content 8-9 wt %, C2 (CF) content 4-5 wt %, C2 (SF) content 30-34 wt %, MFR₂ 32-34 g/10 min, tensile modulus 1300-1400 MPa, Impact strength (charpy test 23° C.) 5-6.5 KJ/m²;

Blend B3:
MFR₂ 18-19 g/10 min, tensile modulus 1200-1300 MPa, Impact strength (charpy test 23° C.) 5-6 KJ/m²;

Blend B4:
total C2 content 9-11 wt %, C2 (CF) content 7-8 wt %, C2 (SF) content 32-33 wt %, MFR₂ 24-25 g/10 min, tensile modulus 1300-1400 MPa, Impact strength (charpy test 23° C.) 5-6 KJ/m²;

Blend B5:
total C2 content 7-9 wt %, C2 (CF) content 5-7 wt %, C2 (SF) content 29-34 wt %, MFR₂ 23-25 g/10 min, tensile modulus 1100-1300 MPa, Impact strength (charpy test 23° C.) 4-5 KJ/m²;

Blend B6:
total C2 content 7-9 wt %, C2 (CF) content 5-7.5 wt %, C2 (SF) content 27-33 wt %, MFR₂ 15-17 g/10 min, tensile modulus 1200-1300 MPa, Impact strength (charpy test 23° C.) 5-6 KJ/m²;

### Dosing Agent:

In some non-limiting embodiments, the polyolefin composition may comprise at least one dosing agent for accepting fillers/pigments during extrusion. The at least one dosing agent may be a polypropylene homopolymer with melt flow rates MFR₂ of 1 to 5 g/10 min, or 2 to 3 g/10 min and a density of 800 to 100 kg/m³, or 900 to 950 kg/m³. Such a polymer is commercially available, for example from Borealis AG.

The amount of dosing agent in the polyolefin composition may be 1-2 wt %, such as 1.2-1.4 wt %.

### Polymer Composition

In the following, some non-limiting embodiments of the polymer composition in accordance with the present disclosure are described.

In some non-limiting embodiments, a polyolefin composition is provided that comprises
a) 35-65 wt % (based on the overall weight of the polyolefin composition) of at least one heterophasic polypropylene copolymer (PPHECO-2) with a total ethylene C2 content of 6-15 wt %, an ethylene content of the soluble fraction C2 (SF) of 25-30 wt % and with a melt flow rate MFR₂ (230° C., 2.16 kg, measured according to ISO 1133) in the range of 65 to 80 g/10 min, or 65 to 75 g/10 min,
b) 35-65 wt % (based on the overall weight of the polyolefin composition) of a blend of recycled plastic material comprising polypropylene and polyethylene in a ratio of 3:7 to 49.5:1, which is recovered from a waste plastic material derived from post-consumer and/or post-industrial waste, with a melt flow rate MFR₂ (230° C., 2.16 kg, measured according to ISO 1133) in the range of 16 to 50 g/10 min or 18 to 40 g/10 min, and
c) optionally further additives, wherein the sum of all ingredients add always up to 100 wt %.

Such a first polyolefin composition may have
a melt flow rate MFR₂ (230° C., 2.16 kg, measured according to ISO 1133) in the range of 30-35 g/10 min;
a tensile modulus (ISO 527-2) in the range of 1450 to 1600 MPa, or 1460 to 1500 MPa;
an impact strength (Charpy 1 eA+23° C.) in the range of 5.5 to 7 kJ/m², or 5.8 to 6.5 kJ/m².

In some non-limiting embodiments, a polyolefin composition is provided that comprises
a) 35-65 wt % (based on the overall weight of the polyolefin composition) of at least one heterophasic polypropylene copolymer (PPHECO-1) with a total ethylene C2 content of 6-15 wt %, an ethylene content of the soluble fraction C2 (SF) of 30-35 wt % and with a melt flow rate MFR₂ (230° C., 2.16 kg, measured according to ISO 1133) in the range of 70 to 90 g/10 min, or 72 to 88 g/10 min;
b) 35-65 wt % (based on the overall weight of the polyolefin composition) of a blend of recycled plastic material comprising polypropylene and polyethylene in a ratio of 3:7 to 49.5:1, which is recovered from a waste plastic material derived from post-consumer and/or post-industrial waste, with a melt flow rate MFR₂ (230° C., 2.16 kg, measured according to ISO 1133) in the range of 16 to 50 g/10 min or 18 to 40 g/10 min, and
c) optionally further additives, wherein the sum of all ingredients add always up to 100 wt %.

Such a polyolefin composition may have
a melt flow rate MFR₂ (230° C., 2.16 kg, measured according to ISO 1133) in the range of 25-36 g/10 min; or 30-35 g/10 min;
a tensile modulus (ISO 527-2) in the range of 1450 to 1600 MPa, or 1460 to 1500 MPa;
an impact strength (Charpy 1 eA+23° C.) in the range of 5.5 to 7 kJ/m², or 5.8 to 6.5 kJ/m².

### Additives

In some non-limiting embodiments, the polyolefin composition may comprise further additives. Examples of additives for use in the composition are pigments and/or dyes (for example carbon black), stabilizers (anti-oxidant agents), anti-acids and/or anti-UVs, antistatic agents, nucleating agents, antiblocking agents and/or utilization agents (such as processing aid agents). Preferred additives are carbon black, at least one antioxidant and/or at least one UV stabilizer.

Generally, the amount of these additives is in the range of 0 to 5.0 wt %, or 0.01 to 3.0 wt %, or 0.01 to 2.0 wt % based on the weight of the total composition.

Non-limiting examples of antioxidants which are commonly used in the art, are sterically hindered phenols (such as CAS No. 6683-19-8, also sold as Irganox 1010 FF™ by BASF), phosphorous based antioxidants (such as CAS No. 31570-04-4, also sold as Hostanox PAR 24 (FF)™ by Clariant, or Irgafos 168 (FF)™ by BASF), sulphur based antioxidants (such as CAS No. 693-36-7, sold as Irganox PS-802 FL™ by BASF), nitrogen-based antioxidants (such as 4,4′-bis(1,1′-dimethylbenzyl)diphenylamine), and/or antioxidant blends. Preferred antioxidants may be Tris (2,4-di-t-butylphenyl) phosphite and/or Octadecyl 3-(3′,5′-di-tert. butyl-4-hydroxyphenyl)propionate.

Anti-acids are also commonly known in the art. Examples are calcium stearates, sodium stearates, zinc stearates, magnesium and zinc oxides, synthetic hydrotalcite (e.g. SHT, CAS-No. 11097-59-9), lactates and lactylates, as well as calcium stearate (CAS No. 1592-23-0) and/or zinc stearate (CAS No. 557-05-1).

Common antiblocking agents are natural silica such as diatomaceous earth (such as CAS No. 60676-86-0 (SuperfFloss™), CAS-No. 60676-86-0 (SuperFloss E™), or CAS-No. 60676-86-0 (Celite 499™)), synthetic silica (such as CAS-No. 7631-86-9, CAS-No. 7631-86-9, CAS-No. 7631-86-9, CAS-No. 7631-86-9, CAS-No. 7631-86-9, CAS-No. 7631-86-9, CAS-No. 112926-00-8, CAS-No. 7631-86-9, or CAS-No. 7631-86-9), silicates (such as aluminium silicate (Kaolin) CAS-no. 1318-74-7, sodium aluminum silicate CAS-No. 1344-00-9, calcined kaolin CAS-No. 92704-41-1, aluminum silicate CAS-No. 1327-36-2, or calcium silicate CAS-No. 1344-95-2), synthetic zeolites (such as sodium calcium aluminosilicate hydrate CAS-No. 1344-01-0, CAS-No. 1344-01-0, and/or sodium calcium aluminosilicate, hydrate CAS-No. 1344-01-0).

Anti-UVs are, for example, Bis-(2,2,6,6-tetramethyl-4-piperidyl)-sebacate (CAS-No. 52829-07-9, Tinuvin 770); 2-hydroxy-4-n-octoxy-benzophenone (CAS-No. 1843-05-6, Chimassorb 81). Preferred UV stabilizers may be low and/or high molecular weight UV stabilizers such as n-Hexadecyl-3,5-di-t-butyl-4-hydroxybenzoate, A mixture of esters of 2,2,6,6-tetramethyl-4-piperidinol and higher fatty acids (mainly stearic acid) and/or Poly((6-morpholino-s-triazine-2,4-diyl)(1,2,2,6,6-pentamethyl-4-piperidyl)imino)hexameth-ylene (1,2,2,6,6-pentamethyl-4-piperidyl)imino)).

Alpha nucleating agents like sodium benzoate (CAS No. 532-32-1); and/or 1,3:2,4-bis(3,4-dimethylbenzylidene)sorbitol (CAS 135861-56-2, Millad 3988). Suitable antistatic agents are, for example, glycerol esters (CAS No. 97593-29-8) or ethoxylated amines (CAS No. 71786-60-2 or 61791-31-9) and/or ethoxylated amides (CAS No. 204-393-1). Usually these additives are added in quantities of 100-2.000 ppm for each individual component of the polymer.

The polyolefin composition according to the present disclosure can be used for a wide range of applications, for example in the manufacture of caps, closures, lids, and/or thin wall packaging.

### Process

As mentioned previously, the polyolefin composition according to the present disclosure is obtained by extruding the at least one heterophasic polypropylene copolymer and the blend of recycled plastic material in the presence of at least one peroxide.

Accordingly, a process for preparing the polyolefin composition as described previously, comprising the steps of
providing
   a) 35-65 wt % (based on the overall weight of the polyolefin composition) of at least one heterophasic polypropylene copolymer with a melt flow rate MFR₂ (230° C., 2.16 kg, measured according to ISO 1133) of at least 40 g/10 min; and
   b) 35-65 wt % (based on the overall weight of the polyolefin composition) of a blend of recycled plastic material comprising polypropylene and polyethylene in a ratio of 3:7 to 49.5:1, which is recovered from a waste plastic material derived from post-consumer and/or post-industrial waste,
feeding/dosing the at least one heterophasic polypropylene copolymer and the blend of recycled plastic material separately or as a mixture into at least one extruder,
melting the mixture in the at least one extruder,
adding at least one peroxide to the molten mixture in the at least one extruder, and
optionally pelletizing the obtained polyolefin composition.

In some non-limiting embodiments of the present process, the at least one heterophasic polypropylene copolymer and the blend of recycled plastic material are provided in granular form and/or as flakes.

Thus, in some non-limiting embodiments of the present process, all polymer ingredients, i.e., virgin heterophasic polypropylene copolymer and recyclate, are provided as granula and may be dosed into the extruder/compounder separately. In some non-limiting embodiments, the granula of the polymer ingredients are premixed and may be dosed as a mixture into the extruder/compounder.

In some non-limiting embodiments, a setup of first extruder and second extruder is used.

Thus, according to some non-limiting embodiments of the present process,
the blend of recycled plastic material is fed into at least one first extruder, in particular a single screw extruder,
the blend of recycled plastic material is molten in the first extruder and the melt of the blend of recycled plastic material is subsequently fed into at least one second extruder,
wherein at least one heterophasic polypropylene copolymer is dosed into the at least one second extruder, and
wherein the at least one peroxide is added to the molten mixture of recycled plastic material and heterophasic polypropylene copolymer in the second extruder.

In some non-limiting embodiments of the present process, flakes of recycled plastic material are dosed into a combination of a single and double screw extruder, wherein in the single screw extruder the recycled plastic material flakes are purified, molten, and optionally provided with additives, the melt of recycled plastic material is subsequently fed into the second double screw extruder, wherein the at least one heterophasic polypropylene copolymer and the at least one peroxide are added to the melt of recycled plastic material.

Thus, flakes of the recyclate undergo processing steps (purification by filtration, degassing, additives) in an extruder (single screw extruder) and are finally granulated. The recyclate granula are then fed into the double screw extruder/compounder separately or together with the heterophasic polypropylene copolymer where they undergo a (second) melting process in the presence of the at least one peroxide.

The present process allows for a targeted adjustment of physical and mechanical properties of the final polyolefin composition. By adding the at least one peroxide to the second extruder it is now possible to adjust the melt flow rate as well as the impact strength and tensile modulus.

By adding the at least one peroxide to the second extruder, and thus to the mixture of molten recycled plastic material and molten heterophasic polypropylene copolymer, the at least one peroxide reacts with both of recycled plastic material and heterophasic polypropylene copolymer. In the course of this reaction, both of recycled plastic material and heterophasic polypropylene copolymer are at least partially degraded. Thus, the polyolefin composition obtained according to this process can also be described as a mixture of partially degraded recycled plastic material and heterophasic polypropylene copolymer.

In contrast, when adding the at least one peroxide only to the recycled plastic material in the first extruder, the at least one peroxide degrades at least partially only the recycled plastic material. The heterophasic polypropylene copolymer added to the second extruder is not degraded.

It is to be noted that the at least one peroxide is dosed to the molten mixture of recycled plastic material and heterophasic polypropylene copolymer in the second extruder at a temperature that allows a complete degradation of the at least one peroxide during the extrusion process.

It is to be noted that screw speed, melt temperature and polymer residence time in the extruder strongly depends on the size of the extruder (such as ab scale or production scale extruder).

The at least one peroxide added in the course of the extrusion process is one of the following: 2,5-Dimethyl-2,5-di(tert-butylperoxy)hexane (commercially available under the tradenames Trigonox 101, Luperox 101, Iniper 101 or Peroxan HX).

The at least one peroxide may be added to the extruder in an amount of at least 0.5 wt %, or at least 0.8 wt %, or at least 1.0 wt % (based on the overall weight of the polyolefin composition), for example in a range of 0.5 wt % to 2.0 wt %, or 0.8 wt % to 1.5 wt %, or 0.9 wt % to 1.2 wt %.

### Experimental Section

The following Examples are included to demonstrate certain non-limiting aspects and embodiments of the present disclosure. It should be appreciated by those of skill in the art, however, that the following description is illustrative only and should not be taken in any way as a restriction of the present disclosure.

### Test Methods

The following definitions of terms and determination methods apply for the above general description of the present disclosure as well as to the below examples unless otherwise defined.

a) Determination of the Content of Isotactic Polypropylene (iPP), Polystyrene (PS), Ethylene, PVC and Polyamide-6 in the Recyclate Blend

### Sample Preparation

All calibration samples and samples to be analyzed were prepared in similar way, on molten pressed plates. Around 2 to 3 g of the compounds to be analyzed were molten at 190° C. Subsequently, for 20 seconds 60 to 80 bar pressure was applied in a hydraulic heating press. Next, the samples were cooled down to room temperature in 40 seconds in a cold press under the same pressure, in order to control the morphology of the compound. The thickness of the plates was controlled by metallic calibrated frame plates 2.5 cm by 2.5 cm, 100 to 200 μm thick (depending MFR from the sample); two plates were produced in parallel at the same moment and in the same conditions. The thickness of each plate was measured before any FTIR measurements; all plates were between 100 to 200 μm thick. To control the plate surface and to avoid any interference during the measurement, all plates were pressed between two double-sided silicone release papers. In case of powder samples or heterogeneous compounds, the pressing process was repeated three times to increase homogeneity by pressed and cutting the sample in the same conditions as described before.

### Spectrometer:

Standard transmission FTIR spectroscope such as Bruker Vertex 70 FTIR spectrometer was used with the following set-up:
a spectral range of 4000-400 cm⁻¹,
an aperture of 6 mm,
a spectral resolution of 2 cm⁻¹,
with 16 background scans, 16 spectrum scans,
an interferogram zero filling factor of 32,
Norton Beer strong apodisation.

Spectrum were recorded and analysed in Bruker Opus software.

### Calibration Samples:

As FTIR is a secondary method, several calibration standards were compounded to cover the targeted analysis range, typically from:
0.2 wt % to 2.5 wt % for PA
0.1 wt % to 5 wt % for PS
0.2 wt % to 2.5 wt % for PET
0.1 wt % to 4 wt % for PVC

The following commercial materials were used for the compounds: Borealis HC600TF as iPP, Borealis FB3450 as HDPE and for the targeted polymers such RAMAPET N1S (Indorama Polymer) for PET, Ultramid® B36LN (BASF) for Polyamide 6, Styrolution PS 486N (Ineos) for High Impact Polystyrene (HIPS), and for PVC Inovyn PVC 263B (under powder form).

All compounds were made at small scale in a Haake kneader at a temperature below 265° C. and less than 10 minutes to avoid degradation. Additional antioxidant such as Irgafos 168 (3000 ppm) was added to minimise the degradation.

### Calibration:

The FTIR calibration principal was the same for all the components: the intensity of a specific FTIR band divided by the plate thickness was correlated to the amount of component determined by ¹H or ¹¹C solution state NMR on the same plate.

Each specific FTIR absorption band was chosen due to its intensity increase with the amount of the component concentration and due to its isolation from the rest of the peaks, whatever the composition of the calibration standard and real samples.

This methodology was described in the publication from Signoret et al. “Alterations of plastic spectra in MIR and the potential impacts on identification towards recycling”, Resources, conservation and Recycling journal, 2020, volume 161, article 104980.

The wavelength for each calibration band was:
3300 cm⁻¹ for PA,
1601 cm⁻¹ for PS,
1410 cm⁻¹ for PET,
615 cm⁻¹ for PVC,
1167 cm⁻¹ for iPP.

For each polymer component i, a linear calibration (based on linearity of Beer-Lambert law) was constructed. A typical linear correlation used for such calibrations is given below:

$$xi = {A}_{i} . \frac{{E}_{i}}{d} + {B}_{i}$$

where xᵢ is the fraction amount of the polymer component i (in wt %)
Eᵢ is the absorbance intensity of the specific band related to the polymer component i (in a.u. absorbance unit). These specific bands are, 3300 cm⁻¹ for PA, 1601 cm⁻¹ for PS, 1410 cm⁻¹ for PET, 615 cm⁻¹ for PVC, 1167 cm⁻¹ for iPP
d is the thickness of the sample plate
Aᵢ and Bᵢ are two coefficients of correlation determined for each calibration curve
No specific isolated band can be found for C2 rich fraction and as a consequence the C2 rich fraction is estimated indirectly,

x_{C2 rich}=100−(x_{iPP}+x_{PA}+x_{PS}+x_{PET}+x_{EVA}+x_{PVC}+x_{chalk}+x_{talc})

The EVA, Chalk and Talc contents are estimated “semi-quantitatively”. Hence, this renders the C2 rich content “semi-quantitative”.

For each calibration standard, wherever available, the amount of each component is determined by either ¹H or ¹³C solution state NMR, as primary method (except for PA). The NMR measurements were performed on the exact same FTIR plates used for the construction of the FTIR calibration curves.

Calibration standards were prepared by blending iPP and HDPE to create a calibration curve. The thickness of the films of the calibration standards were 300 μm. For the quantification of the iPP, PS and PA 6 content in the samples quantitative IR spectra were recorded in the solid-state using a Bruker Vertex 70 FTIR spectrometer. Spectra were recorded on 25×25 mm square films of 50 to 100 μm thickness prepared by compression moulding at 190° C. and 4 to 6 mPa. Standard transmission FTIR spectroscopy was employed using a spectral range of 4000 to 400 cm⁻¹, an aperture of 6 mm, a spectral resolution of 2 cm⁻¹, 16 background scans, 16 spectrum scans, an interferogram zero filling factor of 32 and Norton Beer strong apodisation.

The absorption of the band at 1167 cm⁻¹ in iPP was measured and the iPP content was quantified according to a calibration curve (absorption/thickness in cm versus iPP content in wt %).

The absorption of the band at 1601 cm⁻¹ (PS) and 3300 cm⁻¹ (PA6) were measured and the PS- and PA6 content quantified according to the calibration curve (absorption/thickness in cm versus PS and PA content in wt %). The content of ethylene was obtained by subtracting the content of iPP, PS and PA6 from 100. The analysis was performed as double determination.

b) Amount of Talc and Chalk in recyclate blend were measured by Thermogravimetric Analysis (TGA); experiments were performed with a Perkin Elmer TGA 8000. Approximately 10-20 mg of material was placed in a platinum pan. The temperature was equilibrated at 50° C. for 10 minutes, and afterwards raised to 950° C. under nitrogen at a heating rate of 20° C./min. The weight loss between ca. 550° C. and 700° C. (WCO2) was assigned to CO₂ evolving from CaCO₃, and therefore the chalk content was evaluated as:

$$Chalk content = 100 / 44 \times WCO 2$$

Afterwards the temperature was lowered to 300° C. at a cooling rate of 20° C./min. Then the gas was switched to oxygen, and the temperature was raised again to 900° C. The weight loss in this step was assigned to carbon black (Wcb). Knowing the content of carbon black and chalk, the ash content excluding chalk and carbon black was calculated as:

Ash content=(Ash residue)−56/44×WCO2−Wcb

Where Ash residue is the weight % measured at 900° C. in the first step conducted under nitrogen. The ash content is estimated to be the same as the talc content for the investigated recyclates.

### c) Amount of Paper, Wood in Recyclate Blend

Paper and wood were determined by conventional laboratory methods including milling, floatation, microscopy and Thermogravimetric Analysis (TGA) or floating techniques (dissolution of the polymer and then gravimetric determination of the paper and wood content).

d) Amount of Metals in recyclate blend was determined by x ray fluorescence (XRF).

e) Amount of Limonene in recyclate blend was determined by solid phase microextraction (HS-SPME-GC-MS). Additional details are given below with respect to the specific sample.

### f) Amount of Total Fatty Acids in Recyclate Blend

was determined by solid phase microextraction (HS-SPME-GC-MS).

Additional details are given below with respect to the specific sample.
g) Xylene Cold Solubles (XCS) in recyclate blend are measured at 25° C. according ISO 16152; first edition; 2005-07-01.

### h) Crystex Analysis of Recyclate Blend

### Crystalline and Soluble Fractions Method

The crystalline (CF) and soluble fractions (SF) of the polypropylene (PP) compositions as well as the comonomer content and intrinsic viscosities of the respective fractions were analyzed by the CRYSTEX QC, Polymer Char (Valencia, Spain). The crystalline and amorphous fractions are separated through temperature cycles of dissolution at 160° C., crystallization at 40° C. and re-dissolution in a 1,2,4-trichlorobenzene (1,2,4-TCB) at 160° C. Quantification of SF and CF and determination of ethylene content (C2) of the parent EP copolymer and its soluble and crystalline fractions are achieved by means of an infrared detector (IR4) and an online 2-capillary viscometer which is used for the determination of the intrinsic viscosity (iV).

The IR4 detector is a multiple wavelength detector detecting IR absorbance at two different bands (CH3 and CH2) for the determination of the concentration and the Ethylene content in Ethylene-Propylene copolymers. IR4 detector is calibrated with series of 8 EP copolymers with known Ethylene content in the range of 2 wt % to 69 wt % (determined by ¹³C-NMR spectroscopy) and various concentration between 2 and 13 mg/ml for each used EP copolymer used for calibration.

The amount of Soluble fraction (SF) and Crystalline Fraction (CF) are correlated through the XS calibration to the “Xylene Cold Soluble” (XCS) quantity and respectively Xylene Cold Insoluble (XCI) fractions, determined according to standard gravimetric method as per ISO16152. XS calibration is achieved by testing various EP copolymers with XS content in the range 2-31 wt %.

The intrinsic viscosity (iV) of the parent EP copolymer and its soluble and crystalline fractions are determined with a use of an online 2-capillary viscometer and are correlated to corresponding iV's determined by standard method in decalin according to ISO 1628. Calibration is achieved with various EP PP copolymers with iV=2-4 dL/g.

A sample of the PP composition to be analyzed is weighed out in concentrations of 10 mg/ml to 20 mg/ml. After automated filling of the vial with 1,2,4-TCB containing 250 mg/I 2,6-tert-butyl-4-methylphenol (BHT) as antioxidant, the sample is dissolved at 160° C. until complete dissolution is achieved, usually for 60 min, with constant stirring of 800 rpm.

A defined volume of the sample solution is injected into the column filled with inert support where the crystallization of the sample and separation of the soluble fraction from the crystalline part is taking place. This process is repeated two times. During the first injection the whole sample is measured at high temperature, determining the iV[dl/g] and the C2[wt %] of the PP composition. During the second injection the soluble fraction (at low temperature) and the crystalline fraction (at high temperature) with the crystallization cycle are measured (wt % SF, wt % C2, iV).

EP means ethylene propylene copolymer.

PP means polypropylene.

### i) Regio-Defects: Quantification of Microstructure by NMR Spectroscopy

Quantitative nuclear-magnetic resonance (NMR) spectroscopy was further used to quantify the comonomer content and comonomer sequence distribution of the polymers. Quantitative ¹³C{¹H} NMR spectra were recorded in the solution-state using a Bruker Advance III 400 NMR spectrometer operating at 400.15 and 100.62 MHz for ¹H and ¹³C respectively. All spectra were recorded using a ¹³C optimized 10 mm extended temperature probe head at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatary oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimized tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6k) transients were acquired per spectra.

Quantitative ¹³C{¹H}NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950).

With characteristic signals corresponding to 2,1 erythro regio defects observed (as described in L. Resconi, L. Cavallo, A. Fait, F. Piemontesi, Chem. Rev. 2000, 100 (4), 1253, in Cheng, H. N., Macromolecules 1984, 17, 1950, and in W-J. Wang and S. Zhu, Macromolecules 2000, 33 1157) the correction for the influence of the regio defects on determined properties was required. Characteristic signals corresponding to other types of regio defects were not observed.

The comonomer fraction was quantified using the method of Wang et. al. (Wang, W-J., Zhu, S., Macromolecules 33 (2000), 1157) through integration of multiple signals across the whole spectral region in the ¹³C{¹H}spectra. This method was chosen for its robust nature and ability to account for the presence of regio-defects when needed. Integral regions were slightly adjusted to increase applicability across the whole range of encountered comonomer contents.

For systems where only isolated ethylene in PPEPP sequences was observed the method of Wang et. al. was modified to reduce the influence of non-zero integrals of sites that are known to not be present. This approach reduced the overestimation of ethylene content for such systems and was achieved by reduction of the number of sites used to determine the absolute ethylene content to:

$$E = 0.5 ( S ββ + S βγ + S βδ + 0.5 ( S αβ + S αγ ) )$$

Through the use of this set of sites the corresponding integral equation becomes:

$$E = 0.5 ( {I}_{H} + {I}_{G} + 0.5 ( {I}_{C} + {I}_{D} ) )$$

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

$$E [ mol \% ] = 100 * fE$$

The weight percent comonomer incorporation was calculated from the mole fraction:

$$E [ wt \% ] = 100 * ( fE * 28.06 ) / ( ( fE * 28.06 ) + ( ( 1 - fE ) * 42.08 ) )$$

The comonomer sequence distribution at the triad level was determined using the analysis method of Kakugo et al. (Kakugo, M., Naito, Y., Mizunuma, K., Miyatake, T. Macromolecules 15 (1982) 1150). This method was chosen for its robust nature and integration regions slightly adjusted to increase applicability to a wider range of comonomer contents

j) Melt flow rates were measured with a load of 2.16 kg (MFR₂) at 230° C. (for polypropylene) or 190° C. (for polyethylene) as indicated. The melt flow rate is that quantity of polymer in grams which the test apparatus standardized to ISO 1133 extrudes within 10 minutes at a temperature of 230° C. (or 190° C.) under a load of 2.16 kg.

### k) Tensile Modulus, Tensile Strength, Tensile Strain at Break, Tensile Strain at Tensile Strength, Tensile Stress at Break, Flexural Modulus

The measurements were conducted after 96 h conditioning time (at 23° C. at 50% relative humidity) of the test specimen.

Tensile Modulus was measured according to ISO 527-2 (cross head speed=1 mm/min; 23° C.) using injection moulded specimens as described in EN ISO 1873-2 (dog bone shape, 4 mm thickness).

Tensile strength and tensile Strain at Break was measured according to ISO 527-2 (cross head speed=50 mm/min; 23° C.) using injection moulded specimens as described in EN ISO 1873-2 (dog bone shape, 4 mm thickness).

Tensile Strain at Tensile Strength was determined according to ISO 527-2 with an elongation rate of 50 mm/min until the specimen broke using injection moulded specimens as described in EN ISO 1873-2 (dog bone shape, 4 mm thickness).

Tensile Stress at Break was determined according to ISO 527-2 (cross head speed=50 mm/min) on samples prepared from compression-moulded plaques having a sample thickness of 4 mm.

Flexural modulus is determined according to ISO 178 standard.

l) Impact strength was determined as Charpy Impact Strength according to ISO 179-1/1 eA at +23° C. (Notched) or according to ISO 179-1/1 eU+23° C. (Unnotched) on injection moulded specimens of 80×10×4 mm prepared according to EN ISO 1873-2. According to this standard samples are tested after 96 hours.

In Table 1 several examples (comparative-CE; inventive-IE) are summarized.

Blend B1 of recycled plastic material was used (having a density (determined according to DIN EN ISO 1183) of 916 kg/m³, a melt flow rate (determined according to DIN EN ISO 1133, 230° C./2.16 kg) of 36 g/10 min, a moisture content (determined via a moisture infrared analyzer, 105° C.) of less than 0.1%, a tensile modulus (determined according to DIN EN ISO 527, 1 mm/min) of more than 1100 MPa, a yield stress (determined according to DIN EN ISO 527, 50 mm/min) of more than 24 MPa, and a tensile strain (determined according to DIN EN ISO 527, 50 mm/min) of more than 18%.

The composition of comparative examples and inventive examples underwent the same process steps and conditions.

Flakes of recyclate Blend B1 were dosed into a combination of a single and double screw extruder, wherein in the single screw extruder the recycled plastic material flakes were purified, molten, then the melt of recycled plastic material was subsequently fed into the second extruder, wherein PPHECO-2 and peroxide were added to the melt of recycled plastic material.

Table 1 refers to a polyolefin compositions comprising:
Comparative Example (CE1): blend of recycled material (Blend B1), no addition of peroxide;
Comparative Example (CE2): blend of recycled material (Blend B1) and one heterophasic polypropylene copolymer (PPHeco-2, MFR₂ of 70 g/10 min, T_{c}=112.3° C.); no addition of peroxide in the extrusion process;
Inventive Example (IE1): blend of recycled material (Blend B1) and one heterophasic polypropylene copolymer (PPHeco-2, MFR₂ of 70 g/10 min, T_{c}=112.3° C.); addition of peroxide (=POX, 2,5-Dimethyl-2,5-di-(tert.butylperoxy) hexan as MB, peroxide content 1%) in the extrusion process.

### Manufacturing of PPHeco-2

### Catalyst Preparation

### Raw Materials

TiCl₄ (CAS 7550-45-90) was supplied by commercial source.
20% solution in toluene of butyl ethyl magnesium (Mg(Bu)(Et)), provided by Crompton
2-ethylhexanol, provided by Merck Chemicals
3-Butoxy-2-propanol, provided by Sigma-Aldrich
bis(2-ethylhexyl)citraconate, provided by Contract Chemicals
Viscoplex® 1-254, provided by Evonik
Heptane, provided by Chevron

### Preparation of Mg Complex

3.4 l of 2-ethylhexanol and 810 ml of propylene glycol butyl monoether (in a molar ratio 4/1) were added to a 20 l reactor. Then 7.8 l of a 20% solution in toluene of BEM (butyl ethyl magnesium) provided by Crompton GmbH was slowly added to the well stirred alcohol mixture. During the addition the temperature was kept at 10° C. After addition the temperature of the reaction mixture was raised to 60° C. and mixing was continued at this temperature for 30 minutes. Finally, after cooling to room temperature the obtained Mg-alkoxide was transferred to storage vessel. 21.2 g of Mg alkoxide prepared above was mixed with 4.0 ml bis(2-ethylhexyl) citraconate for 5 minutes. After mixing the obtained Mg complex was used immediately in the preparation of catalyst component.

### Preparation of Catalyst Component

19.5 ml titanium tetrachloride was placed in a 300 ml reactor equipped with a mechanical stirrer at 25° C. Mixing speed was adjusted to 170 rpm. 26.0 of the Mg-complex prepared above was added within 30 minutes keeping the temperature at 25° C. 3.0 ml of Viscoplex 1-254 and 24.0 ml of heptane were added to form an emulsion. Mixing was continued for 30 minutes at 25° C. Then the reactor temperature was raised to 90° C. within 30 minutes. The reaction mixture was stirred for further 30 minutes at 90° C. Afterwards stirring was stopped and the reaction mixture was allowed to settle for 15 minutes at 90° C.

The solid material was washed with 100 ml of toluene, with of 30 ml of TiCl₄, with 100 ml of toluene and two times with 60 ml of heptane. 1 ml of donor D was added to the two first washings. Washings were made at 80° C. under stirring for 30 minutes with 170 rpm. After stirring was stopped the reaction mixture was allowed to settle for 20-30 minutes and followed by siphoning.

Afterwards stirring was stopped and the reaction mixture was allowed to settle for 10 minutes decreasing the temperature to 70° C. with subsequent siphoning, and followed by N₂ sparging for 20 minutes to yield an air sensitive powder.

Catalyst has a surface area measured by BET method below 5 m²/g, i.e. below the detection limit.

### Polymerization:

Borstar pilot plant with a 4-reactor set-up (loop-GPR1-GPR2-GPR3) and a prepolymerization loop reactor.

TABLE 1
Polymerization conditions for PPHeco-2

| Prepolymerisation reactor | | |
|---|---|---|
| Temperature | ° C. | 30 |
| Residence time | h | 0.37 |
| Loop reactor | | |
| Temperature | ° C. | 80 |
| Pressure | kPa | 53 |
| H2/C3 ratio | mol/kmol | 25.4 |
| Polymer Split | wt.-% | 40 |
| Polymer residence time | h | 0.25 |
| MFR₂ | g/10 min | 310 |
| Gas phase reactor 1 | | |
| Temperature | ° C. | 80 |
| Pressure | kPa | 2100 |
| H2/C3 ratio | mol/kmol | 203 |
| Polymer Split | wt.-% | 38 |
| Polymer residence time | h | 1.70 |
| MFR₂ | g/10 min | 339 |
| MFR₂ in GPR1 (calc.) | g/10 min | 210 |
| Gas phase reactor 2 | | |
| Temperature | ° C. | 80 |
| Pressure | kPa | 27 |
| H2/C2 ratio | mol/kmol | 147.3 |
| C2/C3 ratio | mol/kmol | 0 |
| Polymer Split | wt.-% | 40 |
| Polymer residence time | h | 3.1 |
| Gas phase reactor 3 | | |
| Temperature | ° C. | 75 |
| Pressure | kPa | 25 |
| H2/C2 ratio | mol/kmol | 158.8 |
| C2/C3 ratio | mol/kmol | 401.6 |
| Polymer Split | wt.-% | 20 |
| Polymer residence time | h | 1.2 |

The following additives were used: Antioxidants: AO1 (Irganox 1010 (FE)), AO2 (Irganox B 225 (FE)), AO3 (Irganox PS-802 FL); AO4 (AO501 GRA), White Pigment (MB90-White 6-PE-70 35%); Dosing agent: HC001A-B1,

TABLE 2
Polymer compositions and properties.

| Material | unit | CE1 | CE2 | IE1 |
|---|---|---|---|---|
| Blend B1 | wt % | 98.7 | 48.7 | 48.7 |
| PPHeco-2 | wt % | | 50 | 50 |
| Dosing agent | wt % | 1 | 1 | 1 |
| Antioxidant AO4 | wt % | 0.3 | 0.3 | 0.3 |
| (AO501GRA) | | | | |
| POX (1 wt.-% | wt % | no | no | yes |
| based on the | | | | |
| weight of the | | | | |
| compostion) | | | | |
| MFR₂ | g/10 min | 37 | 43.3 | 35 |
| 230° C./2.16 kg | | | | |
| Tensile | MPa | 1308 | 1451 | 1484 |
| modulus 23° C. | | | | |
| Impact strength | kJ/m2 | 5.4 | 4.8 | 5.8 |
| 1eA + 23° C. | | | | |

As can be seen in Table 1 tensile modulus and impact strength of the heterophasic copolymer recyclate composition according to the inventive example IE 1 is higher than the one of the recyclate compositions CE1 and the heterophasic copolymer-recyclate composition CE2. At the same time melt flow rates are comparable.

Thus, the properties of the heterophasic copolymer-recyclate composition according to the present disclosure are characterized by an impact strength and by a tensile modulus indicating a stable material.

1. A polyolefin composition comprising
a) 35-65 wt % (based on the overall weight of the polyolefin composition) of at least one heterophasic polypropylene copolymer with a total ethylene C2 content of 6-15 wt %, an ethylene content of the soluble fraction C2 (SF) content of 25-40 wt % and with a melt flow rate MFR₂ (230° C., 2.16 kg, measured according to ISO 1133) in the range of 60 to 90 g/10 min; and
b) 35-65 wt % (based on the overall weight of the polyolefin composition) of a blend of recycled plastic material comprising polypropylene and polyethylene in a ratio of 3:7 to 49.5:1, which is recovered from a waste plastic material derived from post-consumer and/or post-industrial waste,
c) optionally further additives, wherein the sum of all ingredients always adds up to 100 wt %,
characterized by
an impact strength (ISO179-1, Charpy 1 eA+23° C.) of 5-8 kJ/m²,
a melt flow rate MFR₂ (230° C., 2.16 kg, measured according to ISO 1133) of 30 to 80 g/10 min, and
a tensile modulus (Iso 527-2) of 1450 to 1600 MPa.

2. The polyolefin composition according to claim 1, comprising:
a) 40-60 wt % (based on the overall weight of the polyolefin composition) of the at least one heterophasic polypropylene copolymer;
b) 40-60 wt % (based on the overall weight of the polyolefin composition) of the blend of recycled plastic material comprising polypropylene and polyethylene,
and optionally further additives, wherein the sum of all ingredients always adds up to 100 wt %.

3. The polyolefin composition according to claim 1, having an impact strength (ISO179, Charpy 1 eA+23° C.) of 5.2 to 7.5 kJ/m².

4. The polyolefin composition according to claim 1, having a melt flow rate MFR₂ (230° C., 2.16 kg, measured according to ISO 1133-1) of 30 to 75 g/10 min.

5. The polyolefin composition according to claim 1, having a tensile modulus (ISO 527-2) of 1450 to 1550 MPa.

6. The polyolefin composition according to claim 1, wherein the at least one heterophasic polypropylene copolymer a) is selected from a group comprising
at least one heterophasic polypropylene copolymer (PPHeco-1) having a melt flow rate MFR₂ (230° C., 2.16 kg, measured according to ISO 1133) of 60 to 90 g/10 min;
at least one heterophasic polypropylene copolymer (PPHeco-2) having a melt flow rate MFR₂ (230° C., 2.16 kg, measured according to ISO 1133) of 60 to 90 g/10 min.

7. The polyolefin composition according to claim 1, wherein the blend of recycled plastic material comprising polypropylene and polyethylene has a melt flow rate MFR₂ (230° C., 2.16 kg, measured according to ISO 1133) of at least 5 g/10 min.

8. The polyolefin composition according to claim 1, wherein the blend of recycled plastic material comprises a relative amount of units derived from propylene of greater than 50 wt % with respect to the total weight of the blend of recycled plastic material.

9. The polyolefin composition according to claim 1, wherein the blend of recycled plastic material comprises a relative amount of units derived from ethylene of less than 47 wt % with respect to the total weight of the blend of recycled plastic material.

10. The polyolefin composition according to claim 1, wherein the polyolefin composition is obtained by extruding the at least one heterophasic polypropylene copolymer and the blend of recycled plastic material in the presence of at least one peroxide.

11. A process for preparing the polyolefin composition according to claim 1, comprising
providing
a) 35-65 wt % (based on the overall weight of the polyolefin composition) of at least one heterophasic polypropylene copolymer with a melt flow rate MFR₂ (230° C., 2.16 kg, measured according to ISO 1133) of 60 to 90 g/10 min; and
b) 35-65 wt % (based on the overall weight of the polyolefin composition) of a blend of recycled plastic material comprising polypropylene and polyethylene in a ratio 3:7 to 49.5:1, which is recovered from a waste plastic material derived from post-consumer and/or post-industrial waste,
feeding/dosing the at least one heterophasic polypropylene copolymer and the blend of recycled plastic material separately or as a mixture into at least one extruder,
melting the mixture in the at least one extruder,
adding at least one peroxide to the molten mixture in the at least one extruder, and
optionally pelletizing the obtained polyolefin composition.

12. The process according to claim 11, wherein the blend of recycled plastic material is fed into at least one first extruder, is molten in the first extruder and the melt is subsequently fed into at least one second extruder, wherein at least one heterophasic polypropylene copolymer is dosed into the at least one second extruder and the at least one peroxide is added to the molten mixture of the recycled plastic material and the heterophasic copolymer in the second extruder.

13. The process according to claim 11, wherein flakes of recycled plastic material are dosed into a combination of a single and double screw extruder, wherein in the single screw extruder the recycled plastic material flakes are purified, molten, and optionally provided with additives, the melt of recycled plastic material is subsequently fed into the second double screw extruder, wherein the at least one heterophasic polypropylene copolymer and the at least one peroxide are added to the melt of recycled plastic material.

14. (canceled)

15. An article comprising the polyolefin composition according claim 1.

16. The polyolefin composition according to claim 1, wherein the additive(s) comprise at least one of sterically hindered phenol(s), phosphorous based antioxidant(s), sulphur based antioxidant(s), nitrogen-based antioxidant(s), and/or mixtures thereof.

17. The polyolefin composition according to claim 1, wherein the additive(s) comprise at least one dosing agent which comprises a polypropylene homopolymer with melt flow rates MFR₂ of 1 to 5 g/10 min and a density of 800 to 100 kg/m³.

18. The polyolefin composition according to claim 1, wherein the at least one heterophasic polypropylene copolymer and the blend of recycled plastic material are provided in granular form and/or as flakes.

19. The polyolefin composition according to claim 11, wherein the at least one peroxide comprises 2,5-Dimethyl-2,5-di(tert-butylperoxy)hexane.

20. The polyolefin composition according to claim 11, wherein the at least one peroxide is added to the molten mixture in the at least one extruder in an amount of at least 0.5 wt % based on the overall weight of the polyolefin composition.
